(19) United States
(12) Patent Application Publication
(10) Pub. No.: US 2015/0369346 A1
(43) Pub. Date: Dec. 24, 2015

(54) Tensioner With Overmolded Pivot Arm

(71) Applicant: THE GATES CORPORATION, DENVER, CO (US)

(72) Inventors: Devang Sisodia, Ahmedabad (IN); Muthukaruppan Eswaran, Mangadu (IN)

(21) Appl. No.: 14/312,929

(22) Filed: Jun. 24, 2014

(51) Int. Cl. F16H 7/12

(52) U.S. Cl. CPC F16H 7/1218; F16H 2007/0893

(57) ABSTRACT

A tensioner comprising a base, a pivot arm comprising cast aluminum, a spring disposed between the base and the pivot arm for urging the pivot arm, a pulley journalled to the pivot arm, a steel shaft overmolded within the pivot arm, the shaft pivotally engaged with the base, the shaft comprising a waist portion for connecting to the overmolded pivot arm, and a pin releasably engaged between the pivot arm and the base.

### FIELD OF THE INVENTION

The invention relates to a tensioner, and more particularly, to a tensioner having a shaft with an overmolded pivot arm.

### BACKGROUND OF THE INVENTION

Tensioners are used to apply a preload to belts used in engine accessory drives. A tensioner will typically comprise a pivot arm mounted to a base. A spring between the pivot arm and base urges the pivot arm, and a pulley journalled thereto, into engagement with a belt. This will apply a preload to the belt which assures proper power transmission from the belt to a driven accessory such as an alternator.

The tensioner pivot arm comprises a pivot shaft and arm. The pivot shaft can be press fit into the pivot arm or the combined shaft and pivot arm are cast as a monolithic piece.

A press fit pivot shaft can be prone to becoming misaligned. This is due to a bending moment which is applied to the shaft during operation. Misalignment of the shaft within the arm can lead to premature failure of the tensioner.

For manufacture, overmolding is a process of casting a first material into a predetermined form about a second component. The casting material can either be similar or dissimilar from the receiving component.

Representative of the art is U.S. Pat. No. 6,895,700 which discloses a soleplate for a clothes pressing iron, composed of: a metal sheet having a lower surface that will be directed toward fabrics to be ironed, a lower surface layer that extends form the lower surface and an interior region that is separated from the lower surface by the lower surface layer, the lower surface layer being mechanically hammer-hardened, or work hardened, to have a hardness greater than the hardness of the sheet prior to being mechanically hardened; and a coating that is hard and resistant to scratching covering the lower surface.

What is needed is a tensioner having a steel shaft with an overmolded cast aluminum pivot arm. The present invention meets this need.

### SUMMARY OF THE INVENTION

The primary aspect of the invention is to provide a tensioner having a steel shaft with an overmolded cast aluminum pivot arm.

Other aspects of the invention will be pointed out or made obvious by the following description of the invention and the accompanying drawings.

The invention comprises a tensioner comprising a base, a pivot arm comprising cast aluminum, a spring disposed between the base and the pivot arm for urging the pivot arm, a pulley journalled to the pivot arm, a steel shaft overmolded within the pivot arm, the shaft pivotally engaged with the base, the shaft comprising a waist portion for connecting to the overmolded pivot arm, and a pin releasably engaged between the pivot arm and the base.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a bottom perspective view of the tensioner pivot arm.

FIG. 2 is a top perspective view of the tensioner pivot arm.

FIG. 3 is a top plan view of the tensioner pivot arm.

FIG. 4 is a side cross-sectional view of the tensioner pivot arm.

FIG. 5 is a perspective view of the pivot arm shaft.

FIG. 6 is a cross-sectional view of the pivot arm shaft.

FIG. 7 is a perspective view of the tensioner.

FIG. 8 is a cross-sectional view of the tensioner.

### DETAILED DESCRIPTION OF THE PREFERRED EMBODIMENT

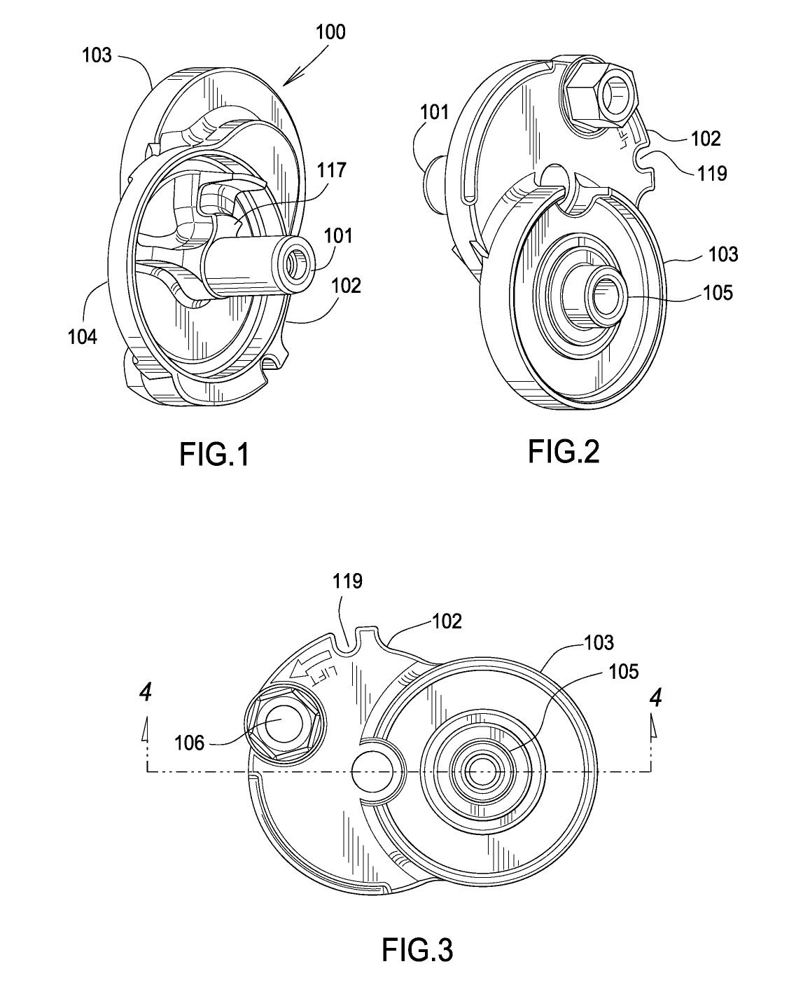

FIG. 1 is a bottom perspective view of the tensioner pivot arm. The tensioner pivot arm 100 comprises pivot arm shaft 101. Shaft 101 is overmolded into pivot arm body 102.

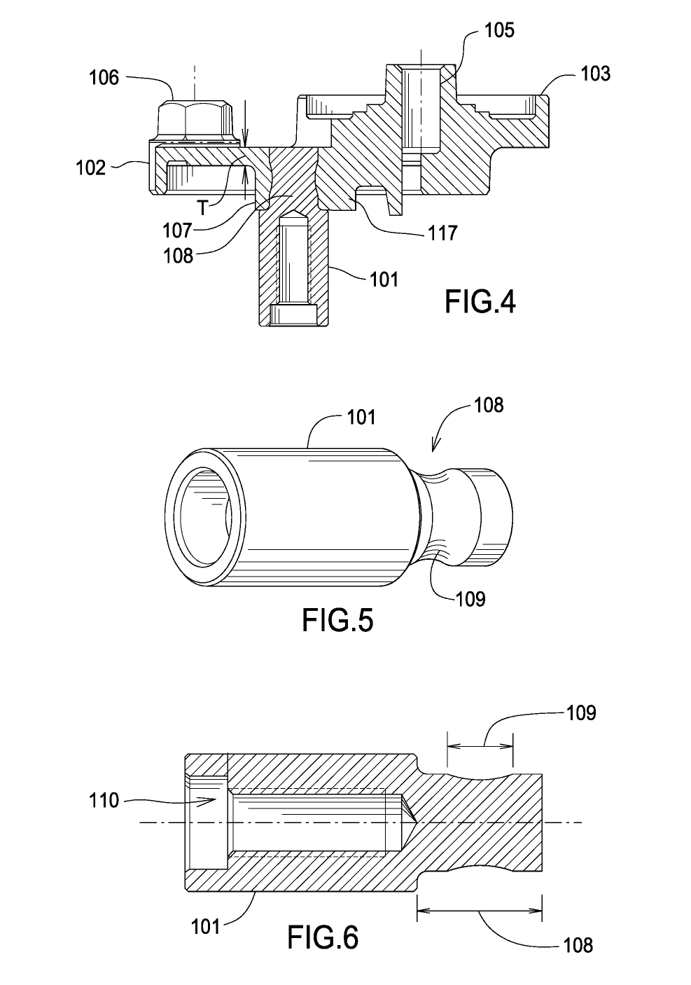

Portion 103 cooperatively engages a tensioner base 104. Portion 103 cooperatively engages a pulley 105. Shaft 101 pivotally engages base 104. Spring 114 butts against damping stop 117. Damping stop 117 also reinforces the overmold joint 107 with shaft 101, see FIG. 4. Damping member 116 bears upon damping stop 117, which damping stop is molded into the pivot arm. Damping member 116 has a frictional engagement with base 104 whereby a pivot arm oscillation is damped.

FIG. 2 is a top perspective view of the tensioner pivot arm. A fastener engages receiver 105, thereby fastening a pulley 105 to the pivot arm 102.

FIG. 3 is a top plan view of the tensioner pivot arm. A tool receiving portion 106 can be engaged by a tool (not shown) for adjusting the tensioner when installed with a belt (not shown). For example, a suitable tool may comprise a ratchet socket, pliers or wrench.

FIG. 4 is a side cross-sectional view of the tensioner pivot arm. Shaft 101 is overmolded into pivot arm 102. Overmold joint portion 107 is molded around portion 108 of shaft 101. For the instant embodiment the pivot arm material comprises cast aluminum, for example, die cast JIS ADC12 aluminum. Shaft 101 comprises steel, for example, SAE J403 1018 steel. The materials specified are offered as examples and are not intended to limit the scope or function of the invention. Any other metal or material possessing similar physical properties will perform with equal success. The limiting aspect being that the melt temperature of the shaft must be greater than the melt temperature of the overmold cast material.

In the prior art, a shaft is typically press fit into the pivot arm. The press fit design can cause the damping shoe to tilt unacceptably over time, thereby degrading alignment and performance. This in turn may cause shaft 101 to bend. Further, the hole may elongate and the pivot arm ultimately fails by separating from the shaft.

The inventive overmolded design corrects the damping shoe tilting problem. Correction of damping shoe tilt ensures stable alignment for a greater duration of operation. Further, by use of overmolding it is possible to maintain better perpendicularity between shaft and arm during manufacturing. During assembly the final alignment of the tensioner assembly will typically fall within 0.5 degree.

As noted, when the alignment of the tensioner deteriorates, the bending moment on the shaft increases which causes stress on the joint with the pivot arm. If hoop stress resistance in the joint is not adequate then the joint may loosen. During testing of the overmolded joint the cast pivot arm will usually fracture at the limit, but the shaft does not come out of the pivot arm hole. For example, facture may occur at about 12,000 Newtons to 15,000 Newtons for the inventive pivot arm configuration. On the other hand, in a prior art press fit joint the shaft may slip out of the pivot arm hole at approximately 6,000 Newtons.

FIG. 5 is a perspective view of the pivot arm shaft. Portion 108 comprises a waist portion 109. Waist portion 109 comprises an arcuate form wherein the diameter of shaft 101 is reduced to approximately 70% of the shaft overall diameter. Waist portion 109 provides means for the overmolded arm to mechanically grip shaft 101. Mechanical engagement enhances shaft 101 resistance to pull-out from pivot arm 102. Waist portion 109 may comprise any profile compatible with the desired connection between the shaft and pivot arm, such as arcuate, angular or grooved. An arcuate form is depicted in FIG. 5.

FIG. 6 is a cross-sectional view of the pivot arm shaft. Hole 110 receives a fastener.

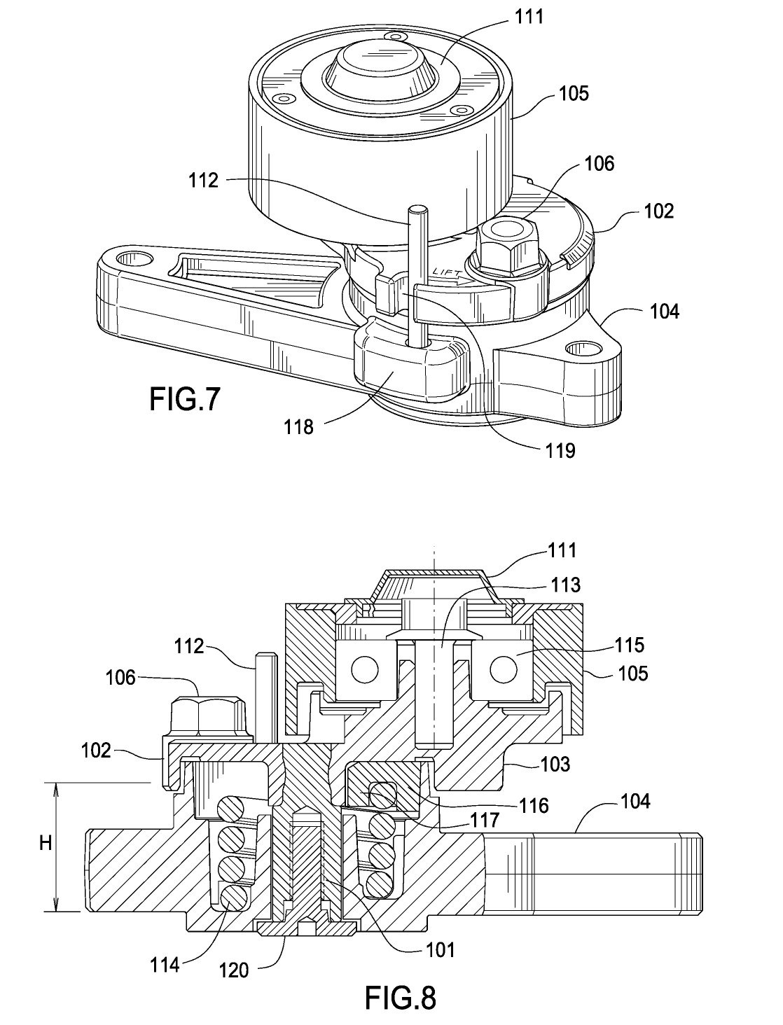

FIG. 7 is a perspective view of the tensioner. Pivot arm 102 is pivotally engaged with base 104. Lock pin 112 engages portion 118 in base 104. Lock pin 112 engages pivot arm 102 at portion 119 to hold the pivot arm in a “ready” position during installation. In the ready position spring 114 is preloaded. Once a belt (not shown) is engaged with the pulley 105, lock pin 112 is removed thereby allowing pivot arm 102 and pulley 105 to pivot into a loaded engagement with the belt.

FIG. 8 is a cross-sectional view of the tensioner. Dust cover 111 prevents debris from contaminating bearing 115. Fastener 113 retains bearing 115 on portion 103.

Torsion spring 114 is disposed between base 104 and pivot arm 102. Torsion spring 114 urges pivot arm 102 into engagement with a belt. Damping member 116 damps movement of pivot arm 102 by frictional engagement with base 104. Fastener 120 engages shaft 101 to pivotally connect pivot arm 102 to base 104.

The overmolded design corrects a damping shoe tilting problem for the reasons given and also because the damping stop feature on the cast arm provides the required support for proper seating of the shoe. The damping stop is a part of the overmolded joint 107 with shaft 101. The overmolded joint can withstand more bending moment than a prior press fit joint. This is advantageous because it is not desirable to package a thicker arm in the available space. For a press fit joint it would be necessary to increase the arm thickness (“T” see FIG. 4) by nearly twice to make an equivalent joint strength compared to the inventive overmolded joint. Increasing the arm thickness T would also have the effect of reducing spring height “H” which would tend to make the spring stiffer. This in turn would adversely affect tension control in a belt drive system.

Although forms of the invention have been described herein, it will be obvious to those skilled in the art that variations may be made in the construction and relation of parts and method without departing from the spirit and scope of the invention described herein.

I claim:

1. A tensioner comprising:
a base (104);
a pivot arm (102) comprising cast aluminum;
a spring (114) disposed between the base and the pivot arm for urging the pivot arm;
a pulley (105) journalled to the pivot arm;
a steel shaft (101) overmolded within the pivot arm, the shaft pivotally engaged with the base;
the shaft comprising a waist portion (109) for connecting to the overmolded pivot arm; and
a pin (112) releasably engaged between the pivot arm and the base.

2. The tensioner as in claim 1, wherein the waist portion is arcuate.

3. The tensioner as in claim 1, wherein the spring comprises a torsion spring.

4. The tensioner as in claim 1 further comprising:
a damping member having a frictional engagement with the base; and
the damping member bearing upon a damping stop molded into the pivot arm.
